(19) United States
(12) Patent Application Publication
(10) Pub. No.: US 2007/0186342 A1
(43) Pub. Date: Aug. 16, 2007

(54) Multi-user foot spa

(76) Inventor: John R. Condon, Portland, OR (US)

Correspondence Address: John R. Condon, 15571 S.E. Oatfield Rd., Portland, OR, 97267, US

(21) Appl. No.: 11/353,632

(22) Filed: Feb. 15, 2006

(51) Int. Cl. A47K 3/022; A61H 35/00; E03C 1/00

(52) U.S. Cl. 4/622

(57) ABSTRACT

A foot spa is disclosed which can accommodate more than one user at once so that a shared experience and relaxing social setting is provided. The invention comprises a water-tight chamber with an open vertical surface, an element for heating water and a motorized pump and tubing for circulating water from the chamber, through the heating element and back into the chamber. Foot spas have been in common usage for therapeutic and recreational purposes. The prior art describes foot baths which accommodate one pair of human feet and hot tub spas which accommodate one or more whole human bodes. However a foot spa designed for more than one pair of feet is novel. Further features including integral seating, textured chamber surfaces, messaging jets, reinforcement to allow in-ground installation, and portability by means of attached wheels are also comprised in the current invention.

### BACKGROUND OF THE INVENTION

Hot tub spas are widely used in the U.S. for therapeutic and recreational purposes. The term “spa” derives from a town in Belgium whose local hot springs became renown for therapeutic bathing. The prior art describes spas which accommodate the full-body immersion of one or several people at once. While a large number of patents have been issued in this field, their specifications explicitly or implicitly describe spas which are designed for the full-body immersion of one or more people.

Spas which accommodate only the lower half of the lower extremities are known as foot spas. Foot spas are known to provide relief of pain caused by fatigue and various ailments. Foot spas also are relaxing to the user and promote a feeling of general well being. The prior art describes foot spas which accommodate only one pair of human feet at one time. A search of the patent literature finds that the specifications of these inventions explicitly or implicitly describe devices which are designed for one pair of human feet. The only foot baths which accommodate a greater number of feet in the prior art are intended for animal feet and are designed for the application of medicinal liquids to livestock by the action of the animals in traversing the foot bath (U.S. Pat. No. 6,739,286 Vander Veen). No foot spas which accommodate more than one pair of human feet are commercially available in the U.S. at this time.

### DESCRIPTION OF THE INVENTION

The invention comprises a chamber which can be filled with aqueous solution having the dimensions which accommodate soaking the feet of a multiplicity of human people. For two people, this would specify a width of at least 20 inches and a breadth of at least 12 inches. Immersion of the feet requires a depth of at least two inches, but not exceeding 20 inches. For a group of four, a width and breadth of 36 inches is appropriate, while for larger groups these dimensions are bounded only by the availability of space.

The invention also possesses components for heating of the aqueous solution to a temperature of 90 to 110° F., be they a heating element, typically electric, or a propane gas heater or wood fired heated. For a bath accommodating four (4) people, the necessary volume of approximately 60 gallons can be effectively heated to the desired temperature range by an in-line electric element. At a rating of 1.5 kW, this element can be heat this volume from an initial temperature of 50° F. in approximately 4 hours, and maintain the desired temperature during bathing and exposure to ambient conditions.

The invention also possesses components for circulating the aqueous liquid at a rate high enough to facilitate the transmission of heat from the in-line heating element.

The advantages of the multi-user foot spa over the full-body immersion spa are as follows: the device provides a therapeutic and relaxing experience in settings having smaller weight or space constraints. The device requires less energy to attain and maintain the desired aqueous liquid temperature. It may be preferred over full body hot tubs in social settings in which wearing bathing attire may be awkward. Hygiene concerns may be reduced among users of multi-user foot spas than among users of full-body spas. And surface contours may be provided to the multi-user foot spa which would be uncomfortable to sit on.

The advantages of the multi-user foot spa over the single user foot spa are as follows: it provides a relaxing atmosphere and a shared experience which encourages intimacy among the users. The energy requirements of a shared foot spa can be lower than that of a multiplicity of individual foot spas. Multi-user foot spas are commonly built around natural hot springs in Japan and are popular social destinations and ornamental facilities. Self-contained multi-user foot spas can provide an ornamental accessory in a garden, on a patio or in a home spa.

The provision of an electric blower which injects pressurized air into the aqueous stream supplies elevated hydrodynamic force to the feet when placed in the vessel. The components which supply high-pressure water flow are commonly termed “jets” and are widely used in full body spas or in foot spas designed to accommodate one pair of human feet. The use of jets in foot spas designed for more than one pair of human feet is novel and does not occur in the prior art.

The provision of integral seating in a foot spa designed to accommodate more than one pair of human feet provides comfort and convenience, is novel and does not occur in the prior art.

The provision of a textured surface within the aqueous chamber facilitates self-administered foot massage. Its application to a foot spa designed to accommodate more than one pair of human feet is novel and does not occur in the prior art.

The provision of wheels mounted on the bottom surface to provide portability and having or not having a handle which is either extensible or non-extensible is novel when applied to a foot spa designed to accommodate more than one pair of human feet and does not occur in the prior art.

Cladding the invention with decay-resistant siding facilitates installations in the earth so that lateral forces are resolved while its top surface is nearly level with the surrounding terrain. It is a common feature among spas designed for full-body immersion, as is disclosed by Horwood (U.S. Pat. No. 6,584,624). However its application to a foot spa designed to accommodate more than one pair of human feet, and less than one whole human body, is novel and does not occur in the prior art.

### DESCRIPTION OF THE FIGURES

FIG. 1: a perspective view of the invention.

FIG. 2: a view of the invention from above.

FIG. 3: a view of the invention along the section line 1-1 of FIG. 2.

Before describing a number of preferred, exemplary, and alternative embodiments of the invention in detail, it is to be understood that the invention is not limited to the details of construction and the arrangement of the components set forth in the following description or illustrated in the drawings. The invention is capable of other embodiments or being practiced or carried out in various ways. It is also to be understood that the phraseology and terminology employed herein is for the purpose of description and should not be regarded as limiting.

### DETAILED DESCRIPTION OF PREFERRED AND OTHER EXEMPLARY EMBODIMENTS

It is also important to note that the construction and arrangement of the elements of the spa apparatus as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, the basin or other components of the spa apparatus may be made from thermoplastic resins such as injection molded high density polyethylene, polyurethane, polypropylene, other polyethylenes, acrylonitrile butadiene styrene (“ABS”), nylon, any of a variety of homopolymer plastics, copolymer plastics, plastics with special additives, filled plastics, steel, aluminum alloys, wood, etc. Also, other fabricating, stamping, or molding operations may be used to form these components. The basin may also be constructed of glass fiber reinforced concrete, a recently developed material which combines strength and low weight with realistic rock-like appearance. Accordingly, all such modifications are intended to be included within the scope of the present invention as described in this application. The sequence or order of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention.

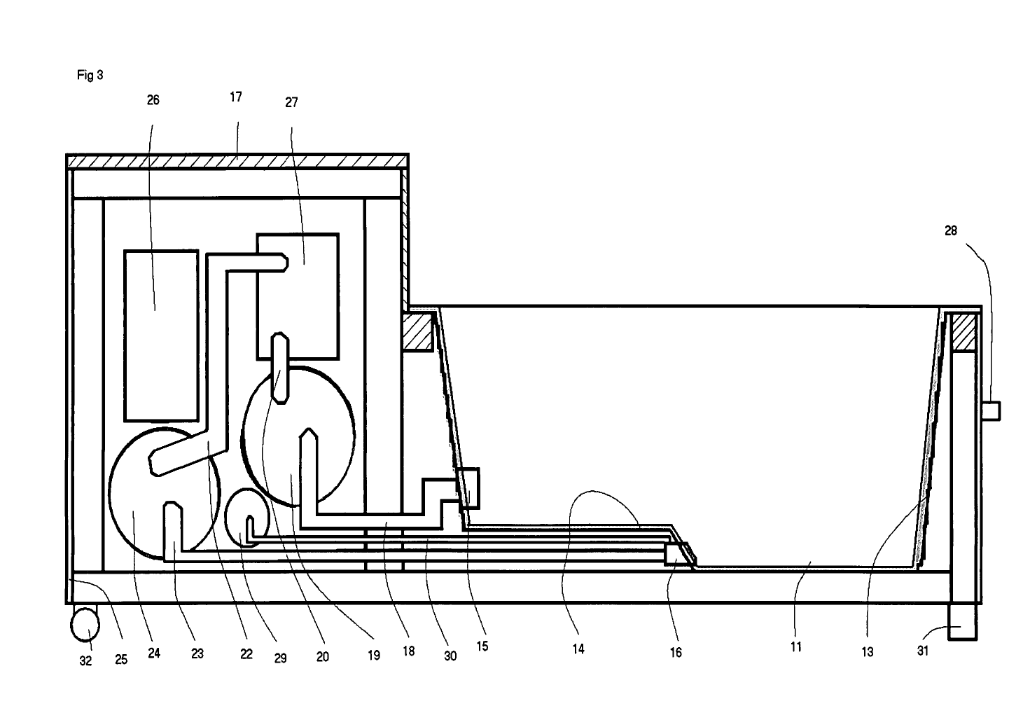

Referring to FIGS. 2 and 3, the foot spa in accordance with the present invention is shown having a chamber 11 for containing aqueous solutions, e.g. water, with an exterior wall 12 and an interior wall 13 and a raised portion 14 to accommodate the passage of tubing connected to output ports 16. A return port 15 is mounted to the interior wall and in this embodiment a platform 17 is attached to the water chamber to provide an integral seat and housing for the mechanical components. These include a circulating pump 19 whose output is communicated by tubing 20 to an optional filtration cartridge 27, which is attached by tubing 22 to an inline electric heater 24. The invention comprises arrangements in which these components are connected in varying order, or having bypasses or multiple components contributing to the same operation. For example, a low power pump may be employed for constant recirculation and a high power pump may be connected as well to provide increased output power at the user's convenience. Or an alternative heat source, such as a propane burner, may be included to increase the start-up heating rate, while the lower power electric heater is used to maintain the water temperature during use.

The input to the mechanical components is communicated from the chamber by tubing 18. The output of the mechanical components is directed to the bath by means of tubing 23 and expelled to the chamber through a nozzle or, as in this embodiment, jets 16. The operation of the mechanical components is determined by a controller 26, which supplies electricity to the pump and heater and any accessories according to the users' selected settings or the operation of a thermostat and/or a timer. The components are encased in a housing 25 to protect them from the surroundings and to protect users from the risk of electric shock by the electrical components within. The optional blower 29 is mounted in this area and its output is conducted to the output jet 16 by a polymer tube 30. The optional wheels 32 are mounted on the bottom at one end and load-leveling feet 31 are mounted on the opposite end. A handle 28 is attached to the side of one end of the apparatus.

When in use, the chamber is filled with water and the controller is activated to power the pump and heater, which increases the temperature to the level determined by the thermostatic controller. The circulation of the water conducts the heat to the water chamber, which, when it has reached a comfortable temperature, can be enjoyed by a multiplicity of persons who place their feet within it.

Jets can be installed in the place of the output ports of the water-carrying tubing. These are equipped with a connection to the water line and a separate connection to a source of pressurized air. Typically a 1 hp blower is used among hot tub spas, and the pressurized air is distributed by means of polymer tubing to each of the jets. The separation of the water and air tubing, and subsequent mixing at the jets, ensures an even flow of the two elements and prevents their separation before entry into the water chamber.

Integral seating can be provided by attaching a platform to the structure of the aqueous solution chamber. The platform should be roughly 16 inches in dimension away from the water chamber to provide adequate support to the user and have a vertical height of roughly 18 inches above the bottom surface of the water chamber to allow comfortable extension of the legs.

An insulating cover can be constructed having a layer of polystyrene foam with a covering of polyvinyl sheet to resist degradation by weather and mechanical abrasion. Its dimensions should match those of the horizontal aspect of the water chamber, having a slight excess in both of the two horizontal dimensions for support. A layer of plywood or extruded polyethylene can be added within the vinyl coating to add mechanical strength.

The textured inner surfaces of the aqueous liquid chamber can be provided in the case of a polymer chamber by shaping the mold from which the chamber is cast. Alternatively or concurrently, monolithic elements such as rocks can be placed in the chamber to provide an interesting and potentially therapeutic surface upon which the user can conduct a self-administered foot massage.

Portability of the foot spa can be provided by mounting wheels on the bottom surface of the foot spa apparatus. Three or more wheels can be distributed widely across the bottom surface, or alternatively, two wheels or one roller can be mounted on one edge of the bottom surface. In this case, a handle, which may be extensible, can be mounted on the opposite end of the apparatus so that when that end is lifted by the handle, the apparatus is tipped up and the weight of the apparatus rests solely on the wheels or roller, facilitating manual movement.

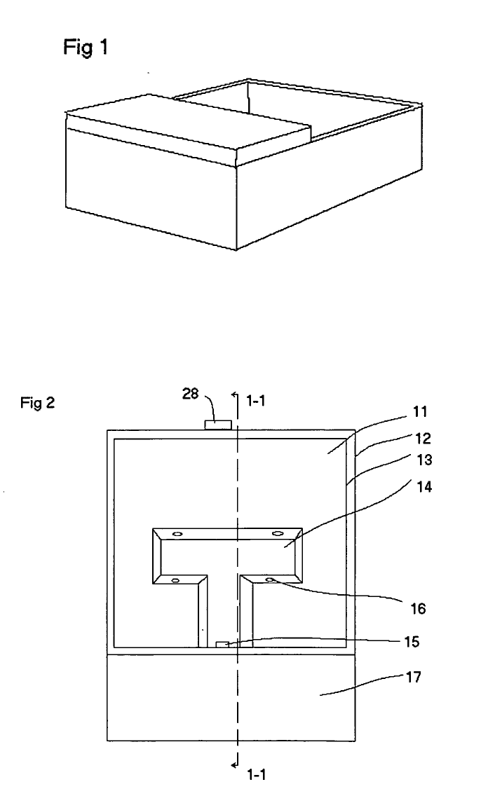

A prototype of the multi-user foot spa has been constructed with the features of FIGS. 1 to 3. The foot spa functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A device with provision for two or more people to bathe their feet simultaneously in warm aqueous liquid having:
a. a vessel to contain aqueous liquid having an open vertical surface being large enough to immerse two pairs of human feet but not large enough to immerse one entire adult human body,
b. a fluid circulating system comprising a) a motorized pump with an output from 0.1 to 100 gallons per minute, b) one or several intake ports, c) intake and output tubing, and d) one or several output ports, together acting to circulate said aqueous liquid in fluid communication with said vessel, and
c. an element which generates heat and transmits said heat to said aqueous liquid in fluid communication with said vessel and said fluid circulating system.

2. The device in claim 1 further including a motorized blower which injects air into the circulation stream of the aqueous liquid.

3. The device in claim 1 further including single or multiple attached seating platforms.

4. The device in claim 1 wherein the aqueous liquid chamber of part (a) has textured inner surfaces either by means of surface modulation or by the presence of monolithic elements such as small rocks.

5. The device in claim 1 further including wheels mounted on the bottom surface and a handle on one or more sides of said device to provide portability.

6. The device in claim 1 further including decay-resistant siding on the outer surfaces of said device to accommodate being installed in the earth so that its top surface is substantially level with the surrounding terrain.
